(19) United States
(12) Patent Application Publication
(10) Pub. No.: US 2026/0200686 A1
(43) Pub. Date: Jul. 16, 2026

(54) WAREHOUSE FOR STORING BATTERY UNIT AND SKID USED IN SAME

(71) Applicant: JGC HOLDINGS CORPORATION, Kanagawa (JP)

(72) Inventors: Noriaki TERAKUBO, Kanagawa (JP); Masatsugu IDO, Kanagawa (JP); Tomohiro SAKURAI, Kanagawa (JP); Keiji TANIGAWA, Kanagawa (JP); Kosuke TAKAISHI, Kanagawa (JP)

(73) Assignee: JGC HOLDINGS CORPORATION, Kanagawa (JP)

(21) Appl. No.: 18/862,176

(22) PCT Filed: May 20, 2022
(86) PCT No.: PCT/JP2022/020928

§ 371 Date: Nov. 1, 2024

(51) Int. Cl. B65G 57/03; H01M 50/249

(52) U.S. Cl. CPC B65G 57/03; H01M 50/249; B65G 2201/02; H01M 2220/20

(57) ABSTRACT

Provided is a battery unit storage warehouse including: a skid, which includes a terminal connectable to a battery unit, and is configured to hold the battery unit; a conductor, which is electrically connectable to the battery unit through intermediation of the terminal, when the skid is stacked to store the battery unit; an overhead crane, configured to stack the skid and remove the skid; and a control device, configured to control the overhead crane.

### TECHNICAL FIELD

The present invention relates to a battery unit storage warehouse and a skid used in the same.

### BACKGROUND ART

As the amount of electric power consumption is increasing, and the amount of electric power generation by renewable energy, such as solar power generation and wind power generation, is increasing, there has been a growing need to stabilize a balance between supply and demand of electric power. At the same time, as devices that use batteries (storage batteries), such as electric vehicles (EVs), are spreading, a supply quantity of batteries has been increasing.

For example, in Patent Literature 1, there is described a storage system including a plurality of rails or tracks that are arranged in a grid pattern on top of a stack of a plurality of containers.

In Patent Literature 2, there is described a warehouse in which a battery voltage is measured under a state in which a tray containing a plurality of batteries is stored on a shelf by a crane.

In Patent Literature 3, there is described a warehouse in which battery accommodation compartments included in a rack include charging accommodation compartments that allow charging of batteries.

In Patent Literature 4, there is described a storage system in which a connecting portion is provided for a storage apparatus for used battery units, and charging and discharging are managed through recognition of a battery status.

### CITATION LIST

### Patent Literature

[Patent Literature 1]: JP 2020-186133 A
[Patent Literature 2]: JP 3435749 B2
[Patent Literature 3]: JP 2011-193690 A
[Patent Literature 4]: JP 6912125 B1

### SUMMARY OF INVENTION

### Technical Problem

Existing battery storage methods have wasteful spaces, and thus, it has been difficult to achieve high density.

The present invention provides a battery unit storage warehouse capable of storing a plurality of battery units at high density.

### Solution to Problem

According to a first aspect of the present invention, there is provided a battery unit storage warehouse, including: a skid, which includes a terminal connectable to a battery unit, and is configured to hold the battery unit; a conductor, which is electrically connectable to the battery unit through intermediation of the terminal, when the skid is stacked to store the battery unit; an overhead crane, configured to stack the skid and remove the skid; and a control device, configured to control the overhead crane.

According to a second aspect of the present invention, in the first aspect, the battery unit storage warehouse is configured to: allow the battery unit held on the skid to store an electric power, and allow a supply of the electric power from the battery unit via the conductor.

According to a third aspect of the present invention, in the second aspect, the battery unit storage warehouse further includes: a power conditioner and a transformer that are connected to the conductor.

According to a fourth aspect of the present invention, in any one of the first to third aspects, the control device is configured to control the overhead crane to remove the battery unit with a reduced capacity.

According to a fifth aspect of the present invention, there is provided a skid configured to be stacked to store a battery unit, the skid including: a function of holding the battery unit, and a terminal configured to allow an electrical connection between the battery unit and an external conductor.

### Advantageous Effects of Invention

According to the first aspect of the present invention, the plurality of battery units can be stored at high density.

According to the second aspect of the present invention, electric power can be stored and supplied using the plurality of battery units.

According to the third aspect of the present invention, it becomes easier to perform adjustment required when the battery units are connected to other power systems.

According to the fourth aspect of the present invention, it becomes easier to remove the battery unit with reduced capacity.

According to the fifth aspect of the present invention, the plurality of battery units can be stored at high density.

### BRIEF DESCRIPTION OF DRAWINGS

FIG. 1 is a front view for illustrating an example of a battery unit storage warehouse according to an embodiment.

FIG. 2 is a schematic view for illustrating an example of an auxiliary device of the battery unit storage warehouse.

### DESCRIPTION OF EMBODIMENTS

Hereinafter, the present invention is described based on the preferred embodiment.

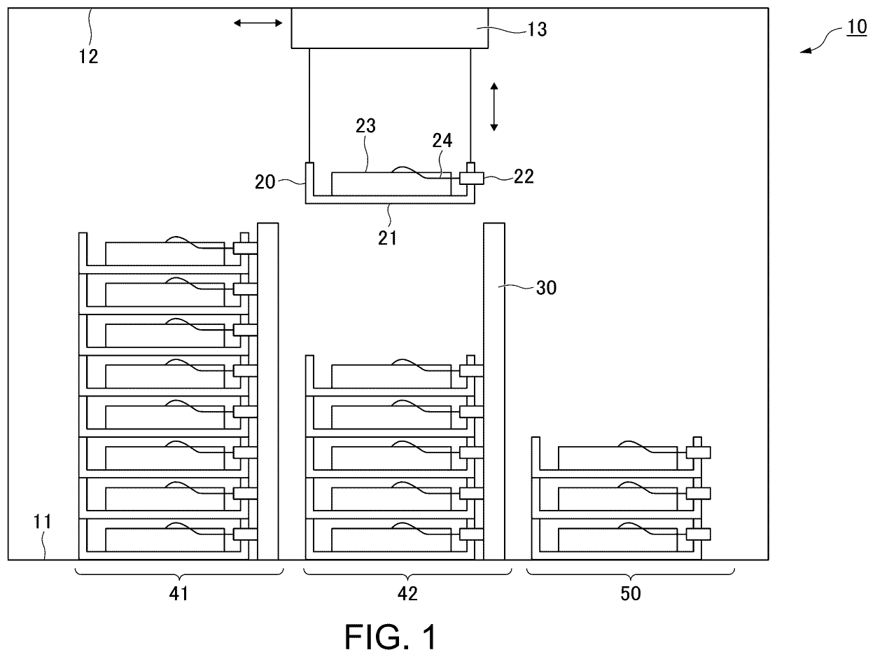

FIG. 1 shows an example of a battery unit storage warehouse 10 according to an embodiment. The battery unit storage warehouse 10 includes a conductor 30 that is electrically connectable to battery units 23 through intermediation of terminals 22 of skids 20 when the skids 20 are stacked to store the battery units 23.

The conductor 30 in the illustrated example is installed vertically so as to extend from a floor 11 to a ceiling 12 of the warehouse. An overhead crane 13 is installed on the ceiling 12 of the warehouse. Through use of the overhead crane 13, the skids 20 can be stacked, and the skids 20 can be removed.

The skid 20 has a function of holding the battery unit 23, and includes the terminal 22 that is connectable to the battery unit 23. The skid 20 in the illustrated example includes a holding section 21 that holds the battery unit 23, and the terminal 22 that is connectable to a cable 24 of the battery unit 23.

The skid 20 can be stacked to store the battery unit 23. Further, the skid 20 allows electrical connection between the battery unit 23 and the conductor 30 external to the skid 20 through intermediation of the terminal 22.

According to the battery unit storage warehouse 10 of the embodiment, the skids 20 respectively holding the battery units 23 are stacked, and thus a load can be supported by the skids 20. The plurality of battery units 23 can be stored at high density without causing the upper and lower battery units 23 to exert a load on each other.

It is preferred that, a gap through which the air can flow for air cooling is defined around the battery units 23 held on the skids 20. The battery unit storage warehouse 10 may include a cooling device (not shown), such as a blower or air conditioning equipment.

The battery unit storage warehouse 10 in the illustrated example includes: stacking regions 41 and 42 in which the skids 20 are stacked for each conductor 30, and a station 50 in which the skids 20 can be stacked without the conductor 30.

The skids 20 stacked in the stacking regions 41 and 42 connect the respective battery units 23 to the conductor 30. The battery units 23 held on those skids 20 can store electric power. Further, the electric power can be supplied from the battery units 23 via the conductor 30. Thus, the electric power can be stored and supplied through use of the plurality of battery units 23.

The skids 20 stacked in the station 50 hold the battery units 23, but do not connect the respective battery units 23 to the conductor 30. Accordingly, the battery units 23 in the station 50 are not used for storing and supplying electric power, and are stored as spare units that can be replaced with the battery units 23 on the skids 20 in the stacking regions 41 and 42. The station 50 can be used as a work space for tasks such as replacing the skids 20 stacked in the stacking regions 41 and 42.

When the skid 20 holding the battery unit 23 is placed in the stacking region 41 or the stacking region 42, it is preferred that, the terminal 22 is connected to the conductor 30. For example, when the skid 20 suspended by the overhead crane 13 is lowered toward the conductor 30, the terminal 22 may be brought into contact with the conductor 30 to allow electrical connection to the conductor 30.

When the skid 20 holding the battery unit 23 is removed from the stacking region 41 or the stacking region 42, it is preferred that, the terminal 22 is disconnected from the conductor 30. For example, when the skid 20 placed in the stacking region 41 or the stacking region 42 is lifted up by the overhead crane 13, the terminal 22 may be separated from the conductor 30 to allow disconnection from the conductor 30.

It is preferred that, a contact state between the terminal 22 and the conductor 30 is maintained, when the skid 20 holding the battery unit 23 is moved up and down. This allows the battery unit 23 to be connected to the conductor 30 without being dependent on a height of the terminal 22 in the stacking region 41 or the stacking region 42.

Each skid 20 may hold two or more battery units 23, or the skids 20 may hold different battery units 23, respectively. When the different skid 20 is used each time the battery unit 23 is placed and removed, it becomes easier to manage the battery unit 23.

The battery unit 23 is a unit representing a group of battery structures that are functionally or physically separable. The battery unit 23 may include a plurality of batteries therein.

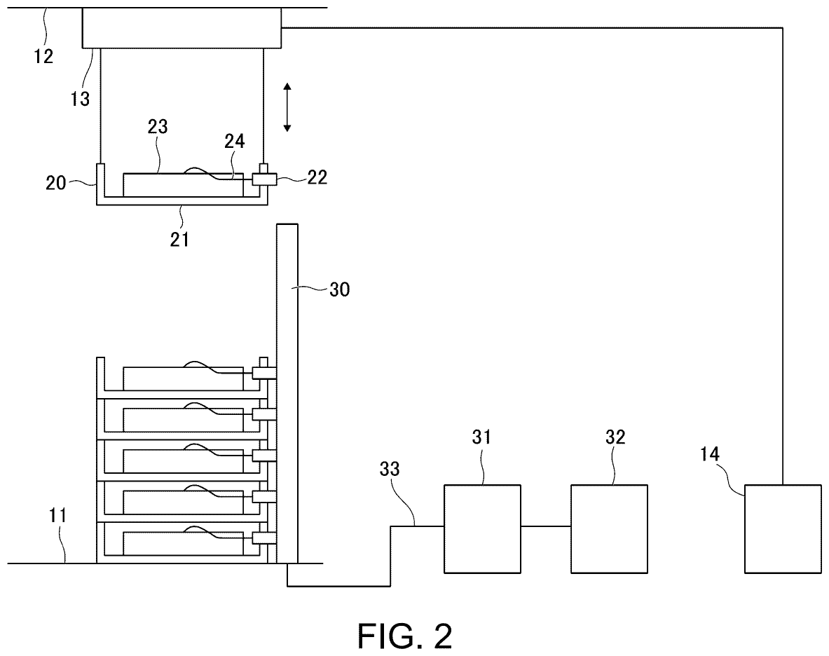

FIG. 2 shows an example of an auxiliary device of the battery unit storage warehouse 10. The battery unit storage warehouse 10 includes a control device 14 that controls the overhead crane 13. The control device 14 may include, for example, an electronic circuit with a program. The control device 14 may include a storage device as required. The storage device can be implemented using, for example, a semiconductor memory or a magnetic hard disk.

When the control device 14 detects the battery unit 23 with reduced capacity in any one of the stacking regions 41 and 42, the control device 14 controls the overhead crane 13 so that the overhead crane 13 removes the skid 20 holding the battery unit 23 with reduced capacity from the stacking region 41 or the stacking region 42. Thus, it becomes easier to remove the battery unit 23 with reduced capacity. Further, the control device 14 can control the overhead crane 13 so that the overhead crane 13 removes the skid 20 from the station 50 and stacks the removed skid 20 in appropriate one of the stacking regions 41 and 42 when the number of the skids 20 stacked in the stacking region 41 or the stacking region 42 is small.

Although a method of connection between the control device 14 and the overhead crane 13 is not particularly limited, a wired connection using, for example, a cable may be adopted, or a wireless connection using, for example, radio waves may be adopted. On the ceiling 12, a rail (not shown) on which the overhead crane 13 is movable may be arranged at an appropriate location.

The battery unit storage warehouse 10 may include a power conditioner 31 and a transformer 32 that are connected to the conductor 30. This enables adjustment required when the battery units 23 connected to the conductor 30 are connected to other power systems.

The power conditioner 31 may have a function of allowing conversion between a direct current in the battery unit 23 and an alternating current in an external power system. The transformer 32 may have a function of allowing transformation between a voltage in the battery unit 23 and a voltage in the external power system.

The conductor 30 can be connected to the power conditioner 31 and the transformer 32 through intermediation of, for example, a connecting cable 33. The connecting cable 33 is flexible, and hence can be laid in any orientation between the conductor 30 and the power conditioner 31 and the transformer 32.

In order to stabilize the balance between supply and demand of electric power as described above, it is required to adjust a supply amount of electric power and a demand amount of electric power. The adjustment of supply and demand of electric power is carried out at appropriate timing between operators involved in transmission or distribution of electric power (transmission and distribution operators) and operators supplying electric power for adjustment (adjustment power).

The general adjustment power is categorized into a primary adjustment power for controlling a frequency, a secondary adjustment power for restoring a frequency to a standard, and a tertiary adjustment power for adjusting the balance between supply and demand. An adjustment speed is set in accordance with a response time from when the transmission and distribution operator requests the supply of the adjustment power to when the adjustment power is supplied. When a high adjustment speed is required, the adjustment power is sometimes supplied based on information detected locally without requiring a communication line.

For the primary adjustment power, for example, a response time of 10 seconds or shorter is required in some cases. For the secondary adjustment power, for example, a response time of 5 minutes or shorter is required in some cases. For the tertiary adjustment power, for example, a response time of 15 minutes or shorter is required for relatively high-speed settings, and a response time of 45 minutes or shorter is required for relatively low-speed settings, in some cases.

According to the battery unit storage warehouse 10 of the embodiment, electric power is stored in the battery unit 23 in advance, and when the adjustment power is required, the electric power is supplied from the battery unit 23, thereby being capable of shortening the response time. The destination of supply of the adjustment power is not particularly limited, but examples of the destination include a power transmission network and a power distribution network of a power grid.

The battery unit 23 to be stored in the battery unit storage warehouse 10 is not particularly limited, but examples of the battery unit 23 may include the battery unit 23 to be used in electric vehicles (EVs) and the used battery unit 23. For example, the battery units 23 that require storage during the process of selling, lending, or recycling used battery units 23 may be stored in the battery unit storage warehouse 10 and used for electric power supply.

When a plurality of battery units 23 are stored in the battery unit storage warehouse 10, timing for taking out a specific battery unit 23 from the battery unit storage warehouse 10 can be set as appropriate.

For example, when a decline in performance due to aging of the battery unit 23 or other causes is detected, the battery unit 23 may be unloaded from the stacking region 41 or the stacking region 42, or the skid 20. The battery unit 23 may be unloaded from the stacking region 41 or the stacking region 42, or the skid 20 due to artificial causes such as demand for transfer or lending of the battery unit 23.

Although the present invention has been described above based on the preferred embodiment, the present invention is not limited to the above-mentioned embodiment, and various modifications are possible within a scope not departing from the gist of the present invention. As the modifications, there are given the addition, replacement, omission, and other changes of the constituent elements in each of embodiments.

### INDUSTRIAL APPLICABILITY

The present invention can be utilized for storing and supplying electric power with use of the battery units.

### REFERENCE SIGNS LIST

10: battery unit storage warehouse, 11: floor, 12: ceiling, 13: overhead crane, 14: control device, 20: skid, 21: holding section, 22: terminal, 23: battery unit, 24: cable, 30: conductor, 31: power conditioner, 32: transformer, 33: connecting cable, 41, 42: stacking region, 50: station.

1. A battery unit storage warehouse, comprising:
a skid, which includes a terminal connectable to a battery unit, and is configured to hold the battery unit;
a conductor, which is electrically connectable to the battery unit through intermediation of the terminal, when the skid is stacked to store the battery unit;
an overhead crane, configured to stack the skid and remove the skid; and
a control device, configured to control the overhead crane.

2. The battery unit storage warehouse according to claim 1, wherein
the battery unit storage warehouse is configured to:
allow the battery unit held on the skid to store an electric power, and
allow a supply of the electric power from the battery unit via the conductor.

3. The battery unit storage warehouse according to claim 2, further comprising:
a power conditioner and a transformer that are connected to the conductor.

4. The battery unit storage warehouse according to claim 1, wherein
the control device is configured to control the overhead crane to remove the battery unit with a reduced capacity.

5. A skid configured to be stacked to store a battery unit, comprising:
a function of holding the battery unit, and
a terminal configured to allow an electrical connection between the battery unit and an external conductor.

6. The battery unit storage warehouse according to claim 2, wherein
the control device is configured to control the overhead crane to remove the battery unit with a reduced capacity.

7. The battery unit storage warehouse according to claim 3, wherein
the control device is configured to control the overhead crane to remove the battery unit with a reduced capacity.
